(19) United States
(12) Patent Application Publication
(10) Pub. No.: US 2013/0119585 A1
(43) Pub. Date: May 16, 2013

(54) METHOD FOR PREPARING POLYMERIC SHEETS DERIVED FROM POLYISOCYANATES

(71) Applicants: Marvin J. Graham, Monroeville, PA (US); George A. Galo, JR., Apollo, PA (US); Matteo Lagasi, Parma (IT); William H. Retsch, JR., Allison Park, PA (US)

(72) Inventors: Marvin J. Graham, Monroeville, PA (US); George A. Galo, JR., Apollo, PA (US); Matteo Lagasi, Parma (IT); William H. Retsch, JR., Allison Park, PA (US)

(21) Appl. No.: 13/661,530

(22) Filed: Oct. 26, 2012

Related U.S. Application Data
(60) Provisional application No. 61/554,023, filed on Nov. 1, 2011.

(51) Int. Cl. B29C 39/02

(52) U.S. Cl. CPC B29C 39/02
USPC 264/331.19

(57) ABSTRACT

Described is a method of preparing a cured, non-elastomeric polymeric sheet derived from a polyisocyanate. The method comprises the following steps: combining a first component and second, separate component to form a reaction mixture; introducing the reaction mixture into a preheated sheet mold at a certain minimum fill rate, allowing the reaction mixture to gel; heating the reaction mixture to a temperature and for a time sufficient to yield a cured sheet having a thickness of at least 6.35 mm (0.25 in); and removing the cured sheet from the mold to yield a non-elastomeric polymeric sheet. When the active hydrogen functional groups in the second component include hydroxyl groups, the first and second components are initially heated to a temperature of at least 50° C., Polyurethane sheets formed by such processes demonstrate minimal optical defects and the process allows for the production of superior sheets of higher thicknesses than previously possible.

### CROSS-REFERENCE TO RELATED APPLICATIONS

The present application claims the benefit of priority from U.S. Provisional Application No. 61/554,023, filed Nov. 1, 2011, which is incorporated by reference herein in its entirety.

### FIELD OF THE INVENTION

The present invention relates to methods of preparing a cured, non-elastomeric polymeric sheet.

### BACKGROUND OF THE INVENTION

Polyurethane, polyurea, and polythiourea articles that provide acceptable optical qualities while maintaining durability and abrasion resistance are sought for a variety of applications, such as displays, windshields, sunglasses, fashion lenses, non-prescription and prescription lenses, sport masks, face shields and goggles.

Casting polymeric sheets having larger dimensions such as at least 900 cm² and having thicknesses of at least A inch has proven challenging because of striations in the final product caused by flow lines of the reactants and exotherms during the cure cycle.

Polyurethane-containing materials and polyurethane-ureas are desirable in the manufacture of optical articles because of their excellent properties such as resilience, and chemical and impact resistance. They have been used in mold castings for lenses, screens, and the like. However, their use has been limited to these small-scale applications because of difficulties in preparing larger sheets of polyurethane-containing polymers that are of similar quality. Such difficulties include low gel time and high viscosity, leading to slow heat transfer, making conventional casting of these materials very difficult.

It would be desirable to provide a method of preparing defect-free polyisocyanate-derived materials in larger sheets, for use in optical elements and articles, so as to take advantage of their superior optical and mechanical properties.

### SUMMARY OF THE INVENTION

In accordance with the present invention, a method of preparing a cured, non-elastomeric polymeric sheet is provided. The polymeric sheets are derived from polyisocyanates. The method allows for the preparation of polymeric sheets having an area of at least 900 cm² and a volume of at least 1600 cm³. The method comprises the following steps:

(a) providing a first component comprising a material having isocyanate functional groups and optionally a catalyst;

(b) providing a second component comprising a material having active hydrogen functional groups that are reactive with isocyanate and optionally a catalyst, wherein the catalyst is present in at least one of the first and second components, and wherein when the active hydrogen functional groups in the second component include hydroxyl groups, the first and second components are initially heated to a temperature of at least 50° C.;

(c) combining the first and second components to form a reaction mixture;

(d) introducing the reaction mixture into a sheet mold at a fill rate of at least 3000 g/min in a substantially uniform thickness, wherein the sheet mold has been pre-heated to a temperature of at least 50° C.;

(e) holding the reaction mixture without additional heating to a higher temperature for a time sufficient to allow the reaction mixture to gel;

(f) heating the reaction mixture to a temperature and for a time sufficient to yield a cured sheet having a thickness of at least 6.35 mm (0.25 in); and

(g) removing the cured sheet from the mold to yield a non-elastomeric polymeric sheet.

### BRIEF DESCRIPTION OF THE DRAWINGS

FIG. 1 is a front perspective schematic view of an open top rectangular mold with a side wall inlet; FIG. 2 is a front perspective schematic view of an open top rectangular mold with a base inlet; FIG. 3 is a front perspective schematic view of an inclined open top rectangular mold with a base inlet.

### DETAILED DESCRIPTION OF THE INVENTION

It is noted that, as used in this specification and the appended claims, the singular forms “a,” “an,” and the include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine, of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are each understood to be non-limiting with respect to the scope of the invention.

As used in the following description and claims, the following terms have the indicated meanings:

The term “cure”, “cured” or similar terms, as used in connection with a cured or curable composition, e,g., a “cured composition” of some specific description, means that at least a portion of the polymerizable and/or crosslinkable components that form the curable composition is at least partially polymerized and/or crosslinked. The term “curable”, as used for example in connection with a curable film-forming composition, means that the indicated composition is polymerizable or cross linkable, e.g., by means that include, but are not limited to, thermal, catalytic, electron beam, chemical free-radical initiation, and/or photoinitiation such as by exposure to ultraviolet light or other actinic radiation. In the context of the present invention, a “cured” composition may continue to be further curable depending on the availability of polymerizable or crosslinkable components.

The term “non-elastomeric” refers to materials that do not exhibit typical elastomeric behavior; i. e., they do not readily undergo reversible deformation or elongation to at least twice their original length.

The terms “on”, “appended to”, “affixed to”, “bonded to”, “adhered to”, or terms of like import means that the designated item, e.g., a coating, film or layer, is either directly connected to (superimposed on) the object surface, or indirectly connected to the object surface, e.g., through one or more other coatings, films or layers (superposed on).

The term “optical quality”, as used for example in connection with polymeric materials, e.g., a “resin of optical quality” or “organic polymeric material of optical quality” means that the indicated material, e.g., a polymeric material, resin, or resin composition, is or forms a substrate, layer, film or coating that can be used as an optical article, such as an ophthalmic lens, or in combination with an optical article, because of its suitable optical properties,

The term “rigid”, as used for example in connection with an optical substrate, means that the specified item is self-supporting.

The term “optical substrate” means that the specified substrate exhibits a light transmission value (transmits incident light) of at least 4 percent and exhibits a haze value of less than 5 percent, e,g., less than 1 percent, (depending on the thickness of the substrate) when measured at 550 nanometers by, for example, a Haze Gard Plus Instrument. Optical substrates include, but are not limited to, optical articles such as lenses, optical layers, e.g., optical resin layers, optical films and optical coatings, and optical substrates having a light influencing property.

The term “tinted”, as used for example in connection with ophthalmic elements and optical substrates, means that the indicated item contains a fixed light radiation absorbing agent, such as but not limited to, conventional coloring dyes, infrared and/or ultraviolet light absorbing materials on or in the indicated item. The tinted item has an absorption spectrum for visible radiation that does not vary significantly in response to actinic radiation.

The term “non-tinted”, as used for example in connection with ophthalmic elements and optical substrates, means that that the indicated item is substantially free of fixed light radiation absorbing agents. The non-tinted item has an absorption spectrum for visible radiation that does not vary significantly in response to actinic radiation.

The term “actinic radiation” includes light with wavelengths of electromagnetic radiation ranging from the ultraviolet (“UV”) light range, through the visible light range, and into the infrared range. Actinic radiation which can be used to cure coating compositions used in the present invention generally has wavelengths of electromagnetic radiation ranging from 150 to 2,000 nanometers (nm), from 180 to 1,000 nm, or from 200 to 500 nm. In one embodiment, ultraviolet radiation having a wavelength ranging from 10 to 390 nm can be used. Examples of suitable ultraviolet light sources include mercury arcs, carbon arcs, low, medium or high pressure mercury lamps, swirl-flow plasma arcs and ultraviolet light emitting diodes. Suitable ultraviolet light-emitting lamps are medium pressure mercury vapor lamps having outputs ranging from 200 to 600 watts per inch (79 to 237 watts per centimeter) across the length of the lamp tube.

The term “transparent”, as used for example in connection with a substrate, sheet, film, material and/or coating, means that the indicated substrate, sheet, coating, film and/or material has the property of transmitting light without appreciable scattering so that objects lying beyond are entirely visible.

According to the present invention, a method of preparing a cured, non-elastomeric polymeric film is provided. The method comprises the following steps:

(a) providing a first component 20 comprising a material having isocyanate functional groups and optionally a catalyst;

(b) providing a second component 22 comprising a material having active hydrogen functional croups that are reactive with isocyanate and optionally a catalyst, wherein the catalyst is present in at least one of the first and second components, and wherein when the active hydrogen functional groups in the second component include hydroxyl groups, the first and second components are initially heated to a temperature of at least 50° C.;

(c) combining the first and second components to form a reaction mixture;

(d) introducing the reaction mixture into a sheet mold 10 at a fill rate of at least 3000 g/min in a substantially uniform thickness, wherein the sheet mold 10 has been pre-heated to a temperature of at least 50° c:

(e) holding the reaction mixture without additional heating to a higher temperature for a time sufficient to allow the reaction mixture to gel;

(f) heating the reaction mixture to a temperature and for a time sufficient to yield a cured sheet having a thickness of at least 6.35 mm (0.25 in); and

(g) removing the cured sheet from the mold 10 to yield a non-elastomeric polymeric sheet.

Using the method of the present invention, it is possible to prepare polymeric sheets having an area of at least 900 cm² and a volume of at least 1600 cm³, while demonstrating minimal optical defects such as striations.

Polyisocyanates useful in the first component are numerous and widely varied. Non-limiting examples can include aliphatic polyisocyanates, cycloaliphatic polyisocyanates wherein one or more of the isocyanato groups are attached directly to the cycloaliphatic ring, cycloaliphatic polyisocyanates wherein one or more of the isocyanato groups are not attached directly to the cycloaliphatic ring, aromatic polyisocyanates wherein one or more of the isocyanate groups are attached directly to the aromatic ring, and aromatic polyisocyanates wherein one or more of the isocyanato groups are not attached directly to the aromatic ring, and mixtures thereof. When an aromatic polyisocyanate is used, generally care should be taken to select a material that does not cause the polyurethane-containing to color (e.g., yellow).

The polyisocyanate can include but is not limited to aliphatic or cycloaliphatic diisocyanates, aromatic diisocyanates, cyclic dimers and cyclic trimers thereof, and mixtures thereof, Non-limiting examples of suitable polyisocyanates can include Desmodur N 3300 (hexamethylene diisocyanate trimer) which is commercially available from Bayer; Desmodur N 3400 (60% hexamethylene diisocyanate dimer and 40% hexarnethylene diisocyanate trimer). In a non-limiting embodiment, the polyisocyanate can include dicyclohexylmethane diisocyanate and isomeric mixtures thereof. As used herein and the claims, the term “Isomeric mixtures” refers to a mixture of the cis-cis, trans-tra and/or cis-trans isomers of the polyisocyanate. Non-limiting examples of isomeric mixtures for use in the present invention can include the trans-trans isomer of 4,4′-methylenebis(cyclohexyl isocyanate), hereinafter referred to as “RCM” (paraisoryanato cyclohexylmethane), the cis-trans isomer of P1 M, the cis-cis isomer of PICM, and mixtures thereof.

Suitable isomers for use in the present invention include but are not limited to the following three isomers of 4,4′-methylenebis(cyclohexyl isocyanate).

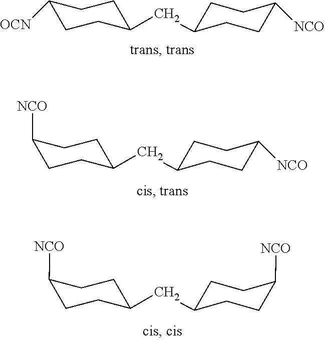

PICM can be prepared by phosgenating 4,4′-methylenelais(cyclohexyl amine) (PACM) by procedures well known in the art such as the procedures disclosed in U.S. Pat. Nos. 2,644,007; 2,680,127 and 2,908,703; which are incorporated herein by reference. The PACM isomer mixtures, upon phosgenation, can produce PICM in a liquid phase, a partially liquid phase, or a solid phase at room temperature. Alternatively, the PACM isomer mixtures can be obtained by the hydrogenation of methylenedianiline and/or by fractional crystallization of PACM isomer mixtures in the presence of water and alcohols such as methanol and ethanol.

Additional aliphatic and cycloaliphatic diisocyanates that can be used include 3-isocyanato-methyl-3,5,5-trimethyl cyclohexyl-isocyanate (“IPDI”) which is commercially available from Arco Chemical, and meta-tetramethylxylene diisocyanate(1,3-bis(1-isocyanato-1-methylethyl)-benzene) which is commercially available from Cytec Industries Inc. under the trade name TMXDI® (Meta) Aliphatic isocyanate.

As used herein and the claims, the term “aliphatic and cycloaliphatic diisocyanates” refers to 6 to 100 carbon atoms linked in a straight chain or cyclized having two diisocyanate reactive end groups. In a non-limiting embodiment of the present invention, the aliphatic and cycloaliphatic diisocyanates for use in the present invention can include TMXDI and compounds of the formula R—(NCO)₂ wherein R represents an aliphatic group or a cycloaliphatic group,

Suitable materials having isocyanate functional groups for use in the first component may alternatively or additionally include polyurethane prepolymers derived from (i) polyisocyanates, including any of those discussed above and (ii) materials having active hydrogen groups that are reactive with isocyanates.

The material (ii) containing active hydrogen groups, used to prepare the isocyanate-functional materials of the first component, may be any compound or mixture of compounds that contain hydroxyl (OH) groups and, if desired, other active hydrogen groups reactive with isocyanate such as primary and/or secondary amine groups. The material (ii) may comprise a compound having at least two active hydrogen groups comprising OH groups, primary amine groups, secondary amine groups, thiol groups, and/or combinations thereof. A single polyfunctional compound having OH groups may be used likewise, a single polyfunctional compound having mixed functional groups may be used. Several different compounds may be used in admixture having the same or different functional groups; e. g., two different polyamines may be used, polythiols mixed with polyamines may be used, or polyamines mixed with hydroxyl functional polythiols, for example, are suitable.

Suitable OH-containing materials for use in the present invention in the preparation of the isocyanate-functional prepolymer material in the first component can include but are not limited to polyether polyols, polyester polyols, polycaprolactone polyols, polycarbonate polyols, and mixtures thereof.

Examples of polyether polyols are polyalkylene ether polyols which include those having the following structural formula:

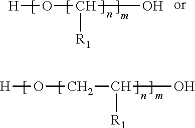

where the substituent R1 is hydrogen or lower alkyl containing from 1 to 5 carbon atoms including mixed substituents, and n is typically from 2 to 6 and m is from 8 to 100 or higher. Included are poly(oxytetramethylene)glycols, poly(oxytetraethylene)glycols, poly(oxy-1,2-propylene)glycols, and poly(oxy-1,2-butylene)glycols. Non-limiting examples of alkylene oxides can include ethylene oxide, propylene oxide, butylene oxide, amylene oxide, aralkylene oxides, such as but not limited to styrene oxide, mixtures of ethylene oxide and propylene oxide. In a further non-limiting embodiment, polyoxyalkylene polyols can be prepared with mixtures of alkylene oxide using random or step-wise oxyalkylation.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for in,stance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from E. I. Du Pont de Nemours and Company, Inc., and POLYMEG, available from Q O Chemicals, Inc., a subsidiary of Great Lakes Chemical Corp.

Polyether glycols for use in the present invention can include but are not limited to polytetramethylene ether glycol.

The polyether-containing polyol can comprise block copolymers including blocks of ethylene oxide-propylene oxide and/or ethylene oxide-butylene oxide, Piuronic R, Pluronic L62D, Tetronic R and Tetronic, which are commercially available from BASF, can be used as the polyether-containing polyol material in the present invention.

Suitable polyester glycols can include but are not limited to the esterification products of one or more dicarboxylic acids having from four to ten carbon atoms, such as adipic, succinic or sebacic acids, with one or more low molecular weight glycols having from two to ten carbon atoms, such as ethylene glycol, propylene glycol, diethylene glycol, 1,4-but-anediol, neopentyl glycol, 1,6-hexanediol and 1,10-decanediol. In a non-limiting embodiment, the polyester glycols can be the esterification products of adipic acid with glycols of from two to ten carbon atoms.

Suitable polycaprolactone glycols for use in the present invention can include the reaction products of E-caprolactone with one or more of the low molecular weight glycols listed above. A polycaprolactone may be prepared by condensing caprolactone in the presence of a difunctional active hydrogen compound such as water or at least one of the tow molecular weight glycols listed above. Particular examples of palycaprolactone glycols include polycaprolactone polyesterdiols available as CAPA® 2047 and CAPA® 2077 from Solvay Corp.

Polycarbonate polyols are known in the art and are commercially available such as Ravecarb™ 107 (Enicher S.p.A). In a non-limiting embodiment, the polycarbonate polyol can be produced by reacting an organic glycol such as a dial and a dialkyl carbonate, such as described in U.S. Pat. No. 4,160,853. In a non-limiting embodiment, the polyol can include polyhexamethyl carbonate having varying degrees of polymerization.

The glycol material can comprise low molecular weight polyols such as polyols having a molecular weight of less than 500, and compatible mixtures thereof. As used herein, the term “compatible” means that the glycols are mutually soluble in each other so as to form a single phase. Non-limiting examples of these polyols can include low molecular weight dials and trials. If used, the amount of triol is chosen so as to avoid a high degree of cross-linking in the polyurethane. A high degree of cross-linking can result in a curable polyurethane that is not formable by moderate heat and pressure. The organic glycol typically contains from 2 to 16, or from 2 to 6, or from 2 to 10, carbon atoms, Non-limiting examples of such glycols can include ethylene glycol, propylene glycol, diethylene glycol, triethylene glycol, tetraethylene glycol, dipropylene glycol, tripropylene glycol, 1,2-, 1,3- and 1,4-butanediol, 2,2,4-trimethyl-1,3-pentanediol, 2-methyl-I, -pentanedial, 1,3-2,4- and 1,5-pentanediol, 2,5- and 1,6-hexanediol, 2,4-heptanediol, 2-ethyl-1,3-nexanediol, 2,2-dimethyl-1,3-propanedial, 1,8-actanediol, 1,9-nonanediol, 1,10-decanediol, 1,4-cyclohexanediol, 1,4-cyclohexanedimethanol, 1,2-bis(hydroxyethyl)-cyclohexane, glycerin, tetrarnethylolmethane, such as but not limited to pentaerythritol, trimethylolethane and trimethylolpropane; and isomers thereof.

The OH-containing material can have a weight average molecular weight, for example, of at least 60, or at least 90, or at least 200. Additionally, the OH-containing material can have a weight average molecular weight, for example, of less than 10,000, or less than 7000, or less than 5000, or less than 2000.

The OH-containing material for use in the present invention can include teresters produced from at least one low molecular weight dicarboxylic acid, such as adipic acid.

Polyester glycols and polycaprolactone glycols for use in the present invention can be prepared using known esterification or transesterification procedures as described, for example, in the article D. M. Young, F. Hostettler et al., “Polyesters from Lactone,” Union Carbide F-40, p. 147,

Polyester glycols can also be prepared from the reaction of 1,6-hexanediol and adipic acid; 1,10-decandiol and adipic acid; or 1,10-decanediol and caprolactone.

In alternate non-limiting embodiments, the OH-containing material for use in the present invention can be chosen from: (a) esterification product of adipic acid with at least one diol selected from 1,4-butanediol, 1,6-hexanediol, neopentyl glycol, or 1,10-decanediol; (b) reaction product of E-caprolactone with at least one diol selected from 1,4-butane diol, 1,6-hexane diol, neopentyl glycol, or 1,10-decanediol; (c) polytetramethylene glycol; (d) aliphatic polycarbonate glycols, and (e) mixtures thereof.

Thiol-containing materials may be used as the second component or to produce a prepolymer such as a sulfur-containing isocyanate-functional polyurethane as the first component for the preparation of high index polyurethane-containing films; i. e., films having a relatively high refractive index. Note that in these embodiments the polyurethane prepolymer used as the first component may contain disulfide linkages due to disulfide linkages contained in the polythiol and/or polythiol oligamer used to prepare the polyurethane prepolymer.

Thiol-containing materials may have at least two thiol functional groups and may comprise a dithiol, or a mixture of a dithiol and a compound having more than two thiol functional groups (higher polythiol). Such mixtures may include mixtures of dithiols and/or mixtures of higher polythiols. The thiol functional groups are typically terminal groups, though a minor portion (i. e., less than 50 percent of all groups) may be pendant along a chain. The compound (a) may additionally contain a minor portion of other active hydrogen functionality (i. e., different from thiol), for example, hydroxyl functionality. Thiol-containing materials may be linear or branched, and may contain cyclic, alkyl, aryl, aralkyl, or alkaryl groups.

Thiol-containing materials may be selected so as to produce a substantially linear oligomeric polythiol. Therefore, the material comprises a mixture of a dithiol and a compound having more than two thiol functional groups, the compound having more than two thiol functional groups can be present in an amount up to 10 percent by weight of the mixture.

Suitable dithiols can include linear or branched aliphatic, cycloaliphatic, aromatic, heterocyclic, polymeric, oligorneric dithiols and mixtures thereof. The dithiol can comprise a variety of linkages including but not limited to ether linkages (—O—) sulfide linkages (—S—), polysulfide linkages (—Sₓ—, wherein x is at least 2, or from 2 to 4) and combinations of such linkages.

Non-limiting examples of suitable dithiols for use in the present invention can include but are not limited'to 2,5-dimercaptomethyl-1,4-dithiane, dimercaptodietnylsuifide (MOS), ethanedithiol, 3,6-dioxa-1,8-octanedithiol, ethylene glycol di(2-mercaptoacetate), ethylene glycol di(3-mercaptopropionate), poly(ethylene glycol) di(2-mercaptoacetate) and poly(ethylene glycol) di(3-mercaptopropionate), benzenedithioi, 4-tert-butyl-1,2-benzenedithiol, 4,4′-thiodibenzenethiol, and mixtures thereof.

The dithiol may include dithiol oligomers having disulfide linkages such as materials represented by the following formula:

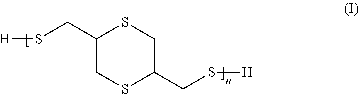

wherein n can represent an integer from 1 to 21.

Dithiol oligomers represented by Formula I can be prepared, for example, by the reaction of 2,5-dimeracaptomethyl-1,4-dithiane with sulfur in the presence of basic catalyst, as known in the art.

The nature of the SH group in polythiols is such that oxidative coupling can occur readily, leading to formation of disulfide linkages. Various oxidizing agents can lead to such oxidative coupling. The oxygen in the air can in some cases lead to such oxidative coupling during storage of the polythiol. It is believed that a possible mechanism for the oxidative coupling of thiol groups involves the formation of thiyl radicals, followed by coupling of said thiyl radicals, to form disulfide linkage. It is further believed that formation of disulfide linkage can occur under conditions that can lead to the formation of thiyl radical, including but not limited to reaction conditions involving free radical initiation. The polythiols for use as compound (a) in the preparation of the polythiols of the present invention can include species containing disulfide linkages formed during storage.

The polythiols for use in material (ii) in the preparation of the isocyanate-functional material in the first component can also include species containing disulfide linkages formed during synthesis of the polythiol.

In certain embodiments, the dithiol for use in the present invention, can include at least one dithiol represented by the following structural formulas:

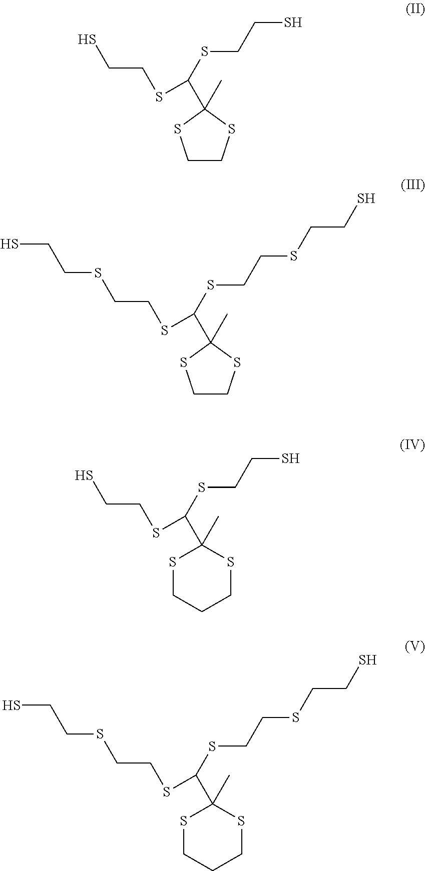 [SMILES: CC1(C(SCCS)SCCS)SCCS1 ; CC1(C(SCCSCCS)SCCSCCS)SCCS1 ; CC1(C(SCCS)SCCS)SCCCS1 ; CC1(C(SCCSCCS)SCCSCCS)SCCCS1]

The sulfide-containing dithiols comprising 1,3-dithiolane (e.g., formulas II and III) or 1,3-dithiane (e.g., formulas IV and V) can be prepared by reacting asym-dichloroacetone with dimercaptan, and then reacting the reaction product with dimercaptoalkylsulfide, dimercaptan or mixtures thereof, as described in U.S. Pat. No. 7,009,032 B2.

Non-limiting examples of suitable dimercaptans for use in the reaction with asym-dichioroacetone can include but are not limited to materials represented by the following formula;

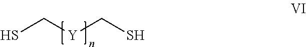

wherein Y can represent CH₂ or (CH₂—S—CH₂), and n can be an integer from 0 to 5. The dimercaptan for reaction with asym-dichloroacetone in the present invention can be chosen from, for example, ethanedithioi propanedithiol, and mixtures thereof.

The amount of asym-dichloroacetone and dimercaptan suitable for carrying out the above reaction can vary. For example, asym-dichioroacetone and dimercaptan can be present in the reaction mixture in an amount such that the molar ratio of dichloroacetone to dimercaptan can be from 1:1 to 1:10.

Suitable temperatures for reacting asym-dichloroacetone with dimercaptan can vary, often ranging from 0 to 100° C.

Non-limiting examples of suitable dimercaptans for use in the reaction with the reaction product of the asym-dichloroacetone and dimercaptan, can include but are not limited to materials represented by the above general formula VI, aromatic dimercaptans, cycloalkyl dimercaptans, heterocyclic dimercaptans, branched dimercaptans, and mixtures thereof.

Non-limiting examples of suitable dimercaptoalkylsulfides for use in the reaction with the reaction product of the asym-dichioroacetone and dimercaptan, can include materials represented by the following formula:

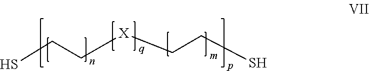

wherein X can represent O, S or Se, n can be an integer from 0 to 10, m can be an integer from 0 to 10, p can be an integer from 1 to 10, q can be an integer from 0 to 3, and with the proviso that (m+n) is an integer from 1 to 20.

Non-limiting examples of suitable dimercaptoalkylsulfides for use in the present invention can include branched dimercaptoalkylsulfides.

The amount of dimercaptan, dimercaptoalkylsuifide, or mixtures thereof, suitable for reacting with the reaction product of asym-dichloroacetone and dimercaptan, can vary. Typically, dimercaptan, dimercaptoalkylsulfide, or a mixture thereof, can be present in the reaction mixture in an amount such that the equivalent ratio of reaction product to dimercaptan, dimercaptoalkylsuifide, or a mixture thereof, can be from 1:1.01 to 1:2. Moreover, suitable temperatures for carrying out this reaction can vary within the range of from 0 to 100° C.

The reaction of asym-dichloroacetone with dimercaptan can be carried out in the presence of an acid catalyst. The acid catalyst can be selected from a wide variety known in the art, such as but not limited to Lewis acids and Bronsted acids. Non-limiting examples of suitable acid catalysts can include those described in Ullmann's Encyclopedia of Industrial Chemistry, 5^{th} Edition, 1992, Volume A21, pp. 673 to 674. The acid catalyst is often chosen from boron trifluoride etherate, hydrogen chloride, toluenesulfonic acid, and mixtures thereof. The amount of acid catalyst can vary from 0.01 to 10 percent by weight of the reaction mixture.

The reaction product of asym-dichloroacetone and dimercaptan can alternatively be reacted with dimercaptoalkylsulfide, dimercaptan or mixtures thereof, in the presence of a base. The base can be selected from a wide variety known in the art, such as but not limited to Lewis bases and Bronsted bases, Non-limiting examples of suitable bases can include those described in Ullmann's Encyclopedia of Industrial Chemistry, 5^{th} Edition, 1992, Volume A21, pp. 673 to 674. The base is often sodium hydroxide. The amount of base can vary. Typically, a suitable equivalent ratio of base to reaction product of the first reaction, can be from 1:1 to 10:1.

The reaction of asym-dichioroacetone with dirnercaptan can be carried out in the presence of a solvent. The solvent can be selected from but is not limited to organic solvents. Non-limiting examples of suitable solvents can include but are not limited to chloroform, dichloromethane, 1,2-dichloroethane, diethyl ether, benzene, toluene, acetic acid and mixtures thereof.

In another embodiment, the reaction product of asym-dichioroacetone and dimercaptan can be reacted with dimercaptoalkylsulfide, dimercaptan or mixtures thereof, with or without the presence of a solvent, wherein the solvent can be selected from but is not limited to organic solvents. Non-limiting examples of suitable organic solvents can include alcohols such as but not limited to methanol, ethanol and propanol; aromatic hydrocarbon solvents such as but not limited to benzene, toluene, xylene; ketones such as but not limited to methyl ethyl ketone; water; and mixtures thereof.

The reaction of asym-dichloroacetone with dirnercaptan can also be carried out in the presence of a dehydrating reagent. The dehydrating reagent can be selected from a wide variety known in the art. Suitable dehydrating reagents for use in this reaction can include but are not limited to magnesium sulfate. The amount of dehydrating reagent can vary widely according to the stoichiometry of the dehydrating reaction.

The polythiols for use in material (ii) in the preparation of the isocyanate-functional material in the first component can be prepared in certain non-limiting embodiments by reacting 2-methyl-2-dichloromethyl-1,3-dithiolane with dimercaptodiethylsuifide to produce dimercapto-1,3-dithiolane derivative of formula lit Alternatively, 2-methyl-2-dichloromethyl-1,3-dithiolane can be reacted with 1,2-ethanedithiol to produce dimercapto-1,3-dithiolane derivative of formula IL 2-methyl-2-dichloromethyl-1,3-dithiane can be reacted with dimercaptodiethylsuifide to produce dimercapto-1,3-dithiane derivative of formula V. Also, 2-methyl-2-dichloromethyl-1,3-dithiane can be reacted with 1,2-ethanedithiol to produce dimercapto-1,3-dithiane derivative of formula IV.

Another non-limiting example of a dithiol suitable for use as the material (ii) can include at least one dithiol oligomer prepared by reacting dichloro derivative with dimercaptoalkylsulfide as follows:

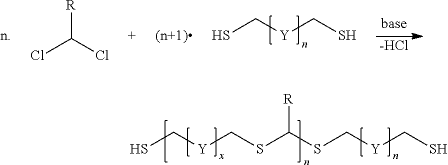

wherein R can represent CH₃, CH₃CO, C₁ to C₁₀ alkyl, cycloalkyl, aryl alkyl, or alkyl-CO; V can represent C₁ to C₁₀ alkyl, cycloalkyl, C₆ to C₁₄ aryl, (CH₂)ₚ(S)_{q}, (CH₂)_{q}, (CH₂)ₚ(Se)ₘ(CH₂)ₚ, (CH₂)ₚ(Te)ₘ(CH₂)_{q} wherein m can be an integer from 1 to 5 and, p and q can each be an integer from 1 to 10; n can be an integer from 1 to 20; and x can be an integer from 0 to 10.

The reaction of dichloro derivative with dimercaptoalkylsulfide can be carried out in the presence of a base. Suitable bases include any known to those skilled in the art in addition to those disclosed above.

The reaction of dichloro derivative with dimercaptoalkylsulfide may be carried out in the presence of a phase transfer catalyst. Suitable phase transfer catalysts for use in the present invention are known and varied. Non-limiting examples can include but are not limited to tetraalkylammonium salts and tetraalkylphosphonium salts. This reaction is often carried out in the presence of tetrabutylphosphonium bromide as phase transfer catalyst. The amount of phase transfer catalyst can vary widely, from 0 to 50 equivalent percent, or from 0 to 10 equivalent percent, or from 0 to 5 equivalent percent, relative to the dimercaptosulfide reactants.

The polythiols for use in material (ii) may further contain hydroxyl functionality. Non-limiting examples of suitable materials having both hydroxyl and multiple (more than one) thiol groups can include but are not limited to glycerin bis(2-mercaptoacetate), glycerin bis(3-mercaptopropionate), 1,3-dimercapto-2-propanol, 2,3-dimercapto-1-propanol, trimethylolpropane bis(2-mercaptoacetate), trimethylolpropane bis(3-mercaptopropionate), pentaerythritol bis(2-mercaptoacetate), pentaerythritol tris(2-mercaptoacetate), pentaerythritol bis(3-mercaptopropionate), pentaerythritol tris(3-mercaptopropionate), and mixtures thereof.

In addition to dithiols disclosed above, particular examples of suitable dithiols can include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane. dipentenedimercaptan, ethylcyclohexyldithiol (ECHDT), dirnercaptodiethylsuifide (DMDS), methyl-substituted dimercaptodiethylsulfide, dimethyl-substituted dimercaptodiethyisulfide, 3,6-dioxa-1,8-octanedithiol, 1,5-dimercapto-3-oxapentane, 2,5-dimercaptornethyl-1,4-dithiane (DMMD),ethylene glycol di(2-mercaptoacetate), ethylene glycol di(3-mercaptopropionate), and mixtures thereof.

Suitable trifunctional or higher-functional polythiols for use in material (ii) can be selected from a wide variety known in the art. Non-limiting examples can include pentaerythritol tetrakis(2-mercaptoacetate), pentaerythritol tetrakis(3-mercaptopropionate), trimethyloipropane tris(2-mercaptoacetate), trimethylolpropane tris(3-mercaptopropionate), and/or thioglycerol bis(2-mercaptoacetate).

For example, the polythiol can be chosen from materials represented by the following general formula,

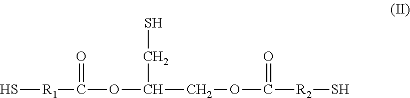

wherein R₁ and R₂ can each be independently chosen from straight or branched chain alkylene, cyclic alkylene, phenylene and C₁-C₉ alkyl substituted phenylene. Non-limiting examples of straight or branched chain alkylene can include methylene, ethylene, 1,3-propylene, 1,2-propylene, 1,4-butylene, 1,2-butylene, pentylene, hexylene, heptylene, octylene, rionylene, decylene, undecylene, octadecylene and icosylene. Non-limiting examples of cyclic alkylenes can include cyclopentylene, cyclohexylene, cycloheptylene, cyclooctylene, and alkyl-substituted derivatives thereof. The divalent linking groups R₁ and R₂ can be chosen from methylene, ethylene, phenylene, and alkyl-substituted phenylene, such as methyl, ethyl, propyl, isopropyl and non-substituted phenylene.

In particular embodiments, a polythiol may be prepared by react,ng together (1) any of the dithiols mentioned above, and (2) a compound having at least two double bonds (for example, a diene).

The compound (2) having at least two double bonds can be chosen from non-cyclic dienes, including straight chain and/or branched aliphatic non-cyclic dienes, non-aromatic ring-containing dienes, including non-aromatic ring-containing dienes wherein the double bonds can be contained within the ring or not contained within the ring or any combination thereof, and wherein the non-aromatic ring-containing dienes can contain non-aromatic monocyclic groups or non-aromatic polycyclic groups or combinations thereof; aromatic ring-containing dienes; or heterocyclic ring-containing dienes; or dienes containing any combination of such non-cyclic and/or cyclic groups. The dienes can optionally contain thioether, disulfide, polysulfide, sulfone, ester, thioester, carbonate, thiocarbonate, urethane, or thiourethane linkages, or halogen substituents, or combinations thereof; with the proviso that the dienes contain double bonds capable of undergoing reaction with SH groups of a polythiol, and forming covalent C—S bonds. Often the compound (2) having at least two double bonds comprises a mixture of dienes that are different from one another.

The compound (2) having at least two double bonds may comprise acyclic non-conjugated dienes, acyclic polyvinyl ethers, allyl-(meth acrylates vinyl-(meth)acrylates, di(meth)acrylate esters of diols, di(meth)acrylate esters of dithiols, di(meth)acrylate esters of poly(alkyleneglycol)diols, monocyclic non-aromatic dienes, polycyclic non-aromatic dienes, aromatic ring-containing dienes, diallyl esters of aromatic ring dicarboxylic acids, divinyl esters of aromatic ring dicarboxylic acids, and/or mixtures thereof.

Non-limiting examples of acyclic non-conjugated dienes can include those represented by the following general formula:

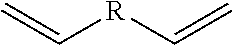

wherein R can represent C₁ to C₃₀ linear or branched divalent saturated alkylene radical, or C₂ to C₃₀ divalent organic radical including groups such as but not limited to those containing ether, thioether, ester, thioester, ketone, polysulfide, sulfone and combinations thereof. The acyclic non-conjugated dienes can be selected from 1,5-hexadiene, 1,6-heptadiene, 1,7-octadiene and mixtures thereof.

Non-limiting examples of suitable acyclic polyvinyl ethers can include those represented by the following structural formula:

CH₂═CH—O—(—R²—O—)ₘ—CH═CH₂

wherein R² can be C₂ to C₆ n-alkylene, C₃ to C₆ branched alkylene group, or —[(CH₂—)ₚ—O—]_{q}—(—CH₂—)ᵣ—, m can be a rational number from 0 to 10, often 2; p can be an integer from 2 to 6, q can be an integer from 1 to 5 and r can be an integer from 2 to 10.

Non-limiting examples of suitable polyvinyl ether monomers for use can include divinyl ether monomers, such as ethylene glycol divinyl ether, diethylene glycol divinyl ether, triethyleneglycol divinyl ether, and mixtures thereof.

Di(meth)acrylate esters of linear dials can include ethanediol di(meth)acrylate, 1,3-propanediol dimethacrylate, 1,2-propanediol di(meth)acrylate, 1,4-butanecliol di(meth)acrylate, 1,3-butanediol di(meth)acrylate, 1,2-butanediol di(meth)acrylate, and mixtures thereof.

Di(meth)acrylate esters of dithiols can include, for example, di(meth)acrylate of 1,2-ethanedithiol including oligomers thereof, di(meth)acrylate of dimercaptodiethyl sulfide (i.e., 2,2′-thioethanedithioi di(meth)acrylate) including oligomers thereof, di(meth)acrylate of 3,6-dioxa-1,8-octanedithiol including oligomers thereof, di(meth)acrylate of 2 mercaptoethyl ether including oligomers thereof, di(meth)acrylate of 4,4′-thiodibenzenethiol, and mixtures thereof.

Further non-limiting examples of suitable dienes can include monocyclic aliphatic dienes such as those represented by the following structural formula:

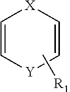

wherein X and Y each independently can represent C₁₋₁₀ divalent saturated alkylene radical; or C₁₋₅ divalent saturated alkylene radical, containing at least one element selected from the group of sulfur, oxygen and silicon in addition to the carbon and hydrogen atoms; and R₁ can represent H, or C₁-C₁₀ alkyl; and

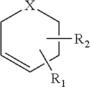

wherein X and R₁ can be as defined above and R₂ can represent C₂-C₁₀ alkenyl. The monocyclic aliphatic dienes can include 1,4-cyclohexadiene, 4-vinyl-1-cyclohexene, dipentene and terpinene.

Non-limiting examples of polycyclic aliphatic dienes can include 5-vinyl-2-norbornene; 2,5-norbornadiene; dicyclopentadiene and mixtures thereof.

Non-limiting examples of aromatic ring-containing dienes can include those represented by the following structural formula:

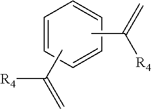

wherein R₄ can represent hydrogen or methyl. Aromatic ring-containing dienes can include monomers such as diisopropenyl benzene, divinyl benzene and mixtures thereof.

Examples of diallyl esters of aromatic ring dicarboxylic acids can include but are not limited to those represented by the following structural formula:

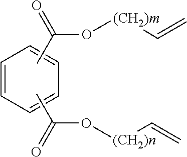

wherein m and n each independently can be an integer from 0 to 5. The diallyl esters of aromatic ring dicarboxylic acids can include o-diallyl phthalate, m-diallyl phthalate, p-diallyl phthalate and mixtures thereof.

Often, the compound (2) having at least two double bonds comprises 5-vinyl-2-norbornene, ethylene glycol divinyl ether, diethylene glycol divinyl ether. Methylene glycol divinyl ether, butane diol divinyl ether, vinylcyclohexene, 4-vinyl-1-cyclohexene, dipentene, terpinene, dicyclopentadiene, cyclododecadiene, cyclooctadiene, 2-cyclopenten-1-yl-ether, 2,5-norbornadiene, divinylbenzene including 1,3-divinylbenzene, 1,2-divinylbenzene, and 1,4-divinylbenzene, dilsopropenylbenzene including 1,3-diisopropenylbenzene, 1,2-diisopropenylbenzene, and diisopropenylbenzene, allyl (meth)acrylate, ethanecliol d(meth)acrylate, 1,3-propanediel di(meth)acrylate, 1,2-propanediol di(meth)acrylate, 1,3-butanediol di(meth)acrylate, 1,2-butanediol di(meth)acrylate, ethylene glycol di(meth)acrylate, diethylene glycol di(meth)acrylate, dimercaptodiethylsulfide di(meth)acrylate, 1,2-ethanedithiol di(meth)acrylate, and/or mixtures thereof.

Other non-limiting examples of suitable di(meth)acrylate monomers can include ethylene glycol di(meth)acrylate, 1,3-butylene glycol di(meth)acrylate, 1,4-butanediol di(meth)acrylate, 2,3-dimethyl-1,3-propanediol di(meth)acrylate, 1,6-hexanediol di(meth)acrylate, propylene glycol di(meth)arrylate, dipropyiene glycol di(meth)acrylate, tripropylene glycol di(meth)acrylate, tetrapropylene glycol di(meth)acrylate, ethoxylated hexanediol di(meth)acrylate, propoxylated hexanediol di(meth)acrylate, neopentyl plycol di(meth)acrylate, alkoxylated neopentyl glycol di(meth)acrylate, hexylene glycol di(meth)acrylate, diethyiene glycol di(meth)acrylate, polyethylene glycol di(meth)acrylate, thiodiethyleneglycol di(meth)acrylate, trimethylene glycol di(meth)acrylate, triethylene glycol di(meth)acrylate, alkoxylated hexanediol di(meth)acrylate, alkoxylated neopentyl glycol di(meth)acrylate, pentanediol di(meth)acrylate, cyclohexane dimethanol di(meth)acrylate, and ethoxylated his-phenol A di(meth)acrylate.

The polythiols for use in material (ii) in the preparation of the isocyanate-functional material in the first component, when reacted with a polyisocyanate (i), can produce a polymerizate having a refractive index of at least 1.50, or at least 1.52, or at least 1.55, or at least 1.60, or at least 1.65, or at least 1.67. Additionally, the polythiols for use in material (ii) in the preparation of the polyurethane material in the first component, when reacted with a polyisocyanate (i), can produce a polymerizate having an Abbe number of at least 30, or at least 35, or at least 38, or at least 39, or at least 40, or at least 44. The refractive index and Abbe number can be determined by methods known in the art such as American Standard Test Method (ASTM) Number D 542-00, using various known instruments. The refractive index and Abbe number can also be measured in accordance with ASTM D 542-00 with the following exceptions: (i) test one to two samples/specimens instead of the minimum of three specimens specified in Section 7.3; and (ii) test the samples unconditioned instead of conditioning the samples/specimens prior to testing as specified in Section 8,1. Further, an Atago model DR-M2 Multi-Wavelength Digital Abbe Refractometer can be used to measure the refractive index and Abbe number of the samples/specimens.

The polythiols for use in material (H) in the preparation of the isocyanate-functional material in the first component, when reacted with a polyisocyanate (i), can produce a polymerizate having a Martens hardness of at least 20 N/mm², or often at least 50, or more often between 70 and 200. Such polymerizates are typically not elastomeric; I. e., they are not substantially reversibly deformable (e. g., stretchable) due to their rigidity and do not typically exhibit properties characteristic of rubber and other elastomeric polymers.

Polyamines are also suitable for use in the material (ii) used to prepare the isocyanate-functional material in the first component, and as the second component having active hydrogen functional groups.

Suitable materials having amine functional groups for use in the material (ii) used to prepare the isocyanate-functional material in the first component may have at least two primary and/or secondary amine groups (polyamine). Non-limiting examples of suitable polyamines include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Non-limiting examples of suitable aliphatic and alicyclic diamines include 1,2-ethylene diamine, 1,2-propylene diamine, 1,8-octane isophororie diamine, propane-2,2-cyclohexyl amine, and the like. Non-limiting examples of suitable aromatic diamines include phenylene diamines and toluene diamines, for example o-phenylene diamine and p-tolylene diamine. Polynuclear aromatic diamines such as 4,4′-biphenyl diamine: 4,4′-methylene dianiline and monochloro- and dichloro-derivatives of 4,4′-methylene dianiline are also suitable.

Suitable polyamines for use in the present invention can include but are not limited to materials having the following chemical formula:

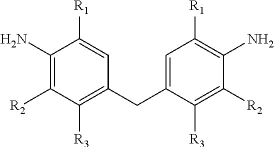

wherein R₁ and R₂ can each be independently chosen from methyl, ethyl, propyl, and isopropyl groups, and R₃ can be chosen from hydrogen and chlorine. Non-limiting examples of polyamines for use in the present invention include the following compounds, manufactured by Lonza Ltd. (Basel, Switzerland):

LONZACURE® M- IPA: R₁═C₃ H₇; R₂═C₃ H₇; R₃═H

LONZACURE® M-DMA: R₁═CH₃; R₂═CH₃; R₃═H

LONZACURE® M-MEA: R₁═CH₃; R₂═C₂ H₅; R₃═H

LONZACURE® M-DEA: R₁═CH₂ H₅; R₂═C₂ H₅; R₃═H

LONZACURE® M-MIPA: R₁═H₃; R₂═C₃ H₇; R₃═H

LONZACURE® M-CDEA: R₁═C₃; J₅; R₂═C₂ H₅; R₃═Cl

wherein R₁, R₂ and R₃ correspond to the aforementioned chemical formula.

The polyamine can include a diamine reactive compound such as 4,4′-methylenebis(3-chloro-2.6-diethylaniline), (Lonzacure® M-CDEA), which is available in the United States from Air Products and Chemical, Inc. (Allentown, Pa.); 2,4-diamino-3,5-diethyl-toluene, 2,6-diamino-3,5-diethyl-toluene and mixtures thereof (collectively “diethyltoluenediamine” or “DETDA”), which is commercially available from Albemarle Corporation under the trade name Ethacure 100; dimethylthiotoluenediamine (DMIDA), which is commercially available from Albemarle Corporation under the trade name Ethacure 300; 4,4′-methylene-bis-(2-chloroaniline) which is commercially available from Kingyorker Chemicals as MOCA. DETDA can be a liquid at room temperature with a viscosity of 156 cPs at 25° C. DETDA can be isomeric, with the 2,4-isomer range being from 75 to 81 percent while the 2,6-isomer range can be from 18 to 24 percent. The color stabilized version of Ethacure 100 (i.e., formulation which contains an additive to reduce yellow color), which is available under the name Ethacure 100S may be used in the present invention.

Other examples of the polyamine can include ethyleneamines. Suitable ethyleneamines can include but are not limited to ethylenediamine (EDA), diethylenetriamine (DETA), triethylenetetramine (TETA), tetraethylenepentamine (TEPA), pentaethylenehexamine (PEHA), piperazine, morpholine, substituted morpholine, piperidine, substituted piperidine, diethylenediamine (DEDA), and 2-amino-1-ethylpiperazine. In particular embodiments, the polyamine can be chosen from one or more isomers of C₁-C₃ dialkyl toluenediamine, such as but not limited to 3,5-dimethyl-2,4-toluenediamine, 3,5-dimethyl-2,6-toluenediamine, 3,5-diethyl-2,4-toluenediamine, 3,5-diethyl-2,6-toluenediamine, 3,5-diisopropyl-2,4-toluenediamine, 3,5-diisopropyl-2,6-toluenediamine, and mixtures thereof. Methylene dianiline and trimethyleneglycol di(para-aminobenzoate) are also suitable.

Additional examples of suitable polyamines include methylene bis anilines, aniline sulfides, and bianilines, any of which may be hetero-substituted, provided the substituents do not interfere with any reactions to take place among the reactants. Specific examples include 4,4′-methylene-bis(2,6-dimethylaniline), 4,4′-methylene-bis(2,6-diethylaniline), 4,4′-methylene-bis(2-ethyl-6-methylaniline), 4,4′-methylene-bis(2,6-diisopropylaniline), 4,4′-methylene-bis(2-isopropyl-6-methylaniline) and 4,4′-methylene-bis(2,6-diethyl-3-chloroaniline).

Frequently used suitable materials having amine functional groups include isomers of diethyiene toluenediamine, methylene dianiline, methyl &isopropyl aniline, methyl diethyl aniline, trimethylene glycol di-para aminobenzoate, 4,4′-methylene-bis(2,6-diisopropylaniline), 4,4′-methylene-bis(2,6-dimethylaniline), 4,4′-methylene-bis(2-ethyl-6--methylaniline), 4,4′-methylene-bis(2,6-diethylaniline), 4,4′-methylene-bis(2-isopropyl-6-methylaniline), and/or 4,4′-methylene-bis(2,6-diethyl-3-chloroaniline). Suitable diamines are also described in detail in U.S. Pat. No. 5,811,506, column 3, line 44, to column 5, line 25, incorporated herein by reference.

In particular embodiments of the present invention, the first component comprises an isocyanate-functional polyurethane prepolymer prepared by reacting 4,4′-methylenebis(cyclohexyl isocyanate) with a polycaprolactone polyol and optionally trimethylolpropane.

In certain embodiments of the present invention the isocyanate functional groups on the material in the first component may be at least partially capped. If isocyanate groups are to be blocked or capped, any suitable aliphatic, cycloaliphatic, or aromatic alkyl monoalcohol or phenolic compound known to those skilled in the art can be used as a capping agent. Examples of suitable blocking agents include those materials which would unblock at elevated temperatures such as lower aliphatic alcohols including methanol, ethanol, and n-butanol: cycloaliphatic alcohols such as cyclohexancl; aromatic-alkyl alcohols such as phenyl carbinol and methylphenyl carbinol, and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as diisopropylamine.

In certain embodiments of the present invention the polyurethane material having isocyanate functional groups in the first component may have a number average molecular weight of at least 5000, such as 6000 to 8000, or at least 10,000, as determined by gel permeation chromatography using a polystyrene standard.

The second component used in the process of the present invention comprises a material having active hydrogen functional groups that are reactive with isocyanate.

Suitable materials having active hydrogen functional groups may include any of those disclosed above as material (ii) in the preparation of the polyurethane prepolymer having isocyanate functional groups in the first component. Often the second component comprises a mixture of 1,4-butanediol and trimethylolpropane.

The equivalent ratio of isocyanate groups (including capped isocyanate groups) in the first component to active hydrogen groups in the second component may range from 1.0:2.0 to 2.0:1.0, depending on the molecular weight of the isocyanate-functional material in the first component. Typically the equivalent ratio of isocyanate groups in the first component to active hydrogen groups in the second component ranges from 1.0:1.5 to 1.5:1.0.

If necessary, the first component 20 and second component 22 can each be heated separately to a temperature of at least 50° C., often up to 110° C., prior to being combined. Preliminary heating of the individual components is particularly useful when the second component is hydroxyl functional as in the making of a polyurethane.

In step (c) of the method of the present invention, the first and second components 20 and 22 are combined to form a reaction mixture. In a typical embodiment, the first and second components are introduced to an impingement point where they are mixed with high shear and thus combined to form a reaction mixture.

In certain embodiments of the present invention, the reaction mixture may further comprise a surfactant. Suitable surfactants may include those sold under the name Modaflow®, available from Solutia, Inc.; BYK-3070 and BYK-3770, available from BYK-Chemie, and/or available from Cytec Surface Specialties. The surfactant may be present in the reaction mixture in an amount of up to 0.2 percent by weight, or up to 0.1 percent by weight, or up to 0.07 percent by weight, based on the total weight of resin solids in the reaction mixture.

In alternate non-limiting embodiments of the present invention, a variety of additives known in the art can be utilized in the reaction mixture. Non-limiting examples include various anti-oxidants, ultraviolet stabilizers, color blockers, optical brighteners, and mold release agents. Suitable anti-oxidants that can be used in the present invention include but are not limited to those of the multifunctional hindered phenol type. One non-limiting example of a multifunctional hindered phenol type anti-oxidant can include irganox 1010 which is commercially available from Ciba Geigy. Suitable UV-stabilizers for use in the present invention include but are not limited to benzotriazoles. Non-limiting examples of benzotriazoie UV-stabilizers include Cyasorb 5411, Cyasorb 3604, and Tinuvin 328, Cyasorb 5411 and 3604 are commercially available from American Cyanamid, and Tinuvin 328 is commercially available from Ciba Geigy.

In an alternative non-limiting embodiment, a hindered amine light stabilizer can be added to enhance UV protection. A non-limiting example of a hindered amine light stabilizer can include Tinuvin 765 which is commercially available from Ciba-Geigy.

In certain embodiments of the present invention, the reaction mixture further comprises a catalyst to aid in the reaction of isocyanate functional groups with active hydrogen functional groups. The catalyst may be initially added to the first and/or second component, usually the second component containing the material having active hydrogen functional croups reactive with isocyanate. Suitable catalysts can be selected from those known in the art. Non-limiting examples can include tertiary amine catalysts such as but not limited to triethylamine, triisopropylamine, dimethyl cyclohexylamine, N,N-dimethylbenzylamine and mixtures thereof. Such suitable tertiary amines are disclosed in U.S. Pat. No. 5,693,738 at column 10, lines 6-38, the disclosure of which is incorporated herein by reference. Other suitable catalysts include phosphines, tertiary ammonium salts, organophosphorus compounds, tin compounds such as dibutyl tin dilaurate, dibutyltin diacetate, or mixtures thereof, depending on the nature of the various reactive components.

The amount of catalyst used may be determined by the desired process conditions, such as the operating temperature. For example, higher catalyst amounts may be used if the reaction mixture is to be heated to a lower temperature during the cure cycle. In an exemplary embodiment, 80 ppm dibutyltin diacetate catalyst in the second component is sufficient for the preparation of sheets at a cure temperature of 80° C. Catalyst amounts may also be adjusted to control certain aspects of the process of the present invention. For example, higher catalyst amounts may be used to decrease the gel time of the reaction mixture in the mold.

After the first and second components 20 and 22 are combined to form the reaction mixture, the reaction mixture is introduced to a sheet mold 10 through an inlet 18. The sheet mold 10 is typically pre-heated to a temperature of at least 50° C., often 60-110° C., prior to introduction of the reaction mixture into the mold 10. The sheet mold 10 is of such dimensions to allow for the preparation of a polyurethane sheet having an area of at least 900 cm² and a volume of at least 1600 cm³.

The reaction mixture is introduced to the sheet mold 10 at a flow rate of at least 3000 g/min and is done in a manner to yield a sheet of substantially uniform thickness. In certain embodiments, for example, to prepare a sheet having an area of at least 1600 cm² and a volume of at least 12,000 cm³, the reaction mixture may be introduced to the sheet mold 10 at a flow rate of at least 7000 g/min. Higher flow rates are particularly useful in the preparation of thicker sheets, such as at least 10 mm thick. In particular embodiments, the reaction mixture may be introduced to the sheet mold 10 under laminar flow. This is especially useful in the preparation of polyurethane sheets having an area of at least 1600 cm² and/or a volume of at least 12,000 cm³.

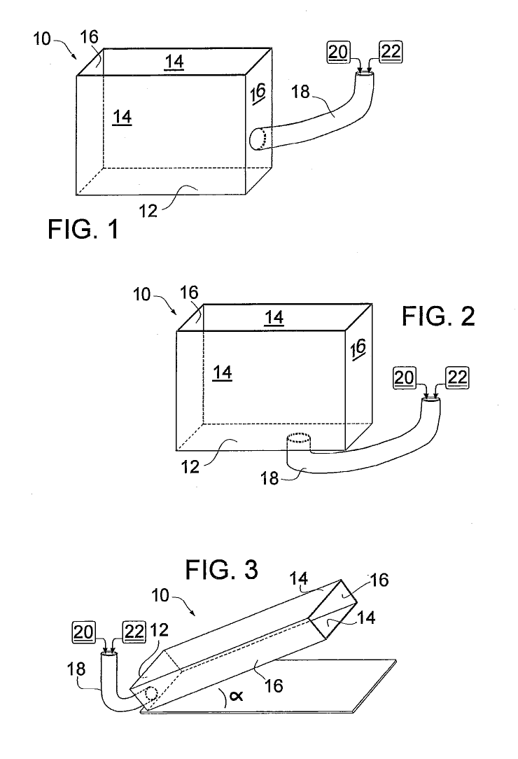

The mold 10 may be any shape desired such as square, rectangular, circular, oval, or any other shape needed depending on the final application of the polyurethane sheet to be formed, provided it has an area of at least 900 cm² and can accommodate a volume of the reaction mixture to yield a final product having a volume of at least 1600 cm³. FIGS. 1 through 3 illustrate rectangular molds. The mold 10 typically has an open top, side walls 16 and side faces 14. The mold may be oriented such that the side face 14, of the mold is planar and oriented vertically, as shown in FIGS. 1 and 2, or at any angle a to the horizontal, as shown in FIG. 3. In certain embodiments, the mold is oriented such that the side face 14 of the mold is at an angle to the horizontal of at least 10°, such as at least 45°. This may be done, for example, by tilting the mold.

The reaction mixture may be introduced to the sheet mold 10 through one or more of various inlets 18. It may be introduced into the open top of the mold, although in the making of a polyurethane this is not preferred. The reaction mixture may alternatively be introduced into the mold 10 through an inlet that may be situated in the floor of the mold as shown in FIGS. 2 and 3 or in a side wall 16 of the mold, as shown in FIG. 1. Alternatively, a side wall 16 or a section thereof may be open to allow for filling of the mold. Filling the mold through an inlet located in a side wall or floor of the mold allows for the preparation of thicker sheets, such as at least 10 mm thick, while maintaining the desired optical properties of the final product. The reaction mixture is allowed to flow into the mold and fill the mold to the desired capacity, while maintaining a substantially uniform thickness of the mixture due to side faces 14. In certain embodiments of the invention the mold may be oriented at an angle a to the horizontal and when the reaction mixture is introduced to the mold 10, the mixture is allowed to flow up (when the inlet is in the floor 12 of the mold, as in FIG. 3) or down (when the inlet is near the higher end of the mold) the inclined plane of a side face 14 to fill the mold and form a sheet having a substantially uniform thickness.

The reaction mixture is then held in the mold for a time sufficient to allow the reaction mixture to gel. Gel times are typically at least ten minutes, but may be shorter depending on initial temperatures of the reactants and mold, catalyst levels, and the identity of the reactants themselves. Usually no additional heating takes place in this step.

After gelling, the reaction mixture is then heated to a temperature and for a time sufficient to yield a cured sheet. The temperature can be maintained at the temperature of the reactants when they were introduced into the mold, or it can be increased to a higher temperature. For example, the heating or curing operation may be carried out at a temperature in the range of from 50° C. to 210° C., such as 100° C. to 150° C., for 100 minutes to 24 hours, such as from 6 to 20 hours. In a typical reaction, the reaction mixture is heated to a temperature of 125° C. for 16 hours.

The reaction mixture is typically cast into the sheet mold in a substantially uniform thickness to yield a cured sheet thickness of at least 6.35 mm; for example, 12.7 to 76.2 mm thick sheets are obtainable using the process of the present invention. Cure temperatures and dwell times will be dependent on the nature of the reactants, including type of reactive groups, the amount and identity of any catalysts, etc.

After an effective curing operation, the cured sheet may be removed from the mold to yield a non-elastomeric polymeric sheet.

The cured, non-elastomeric polymeric sheet prepared according to the method of the present invention is essentially free of striation defects and may be used to form optical articles in which clarity is essential, such as glazings.

The present invention is more particularly described in the following examples that are intended as illustration only, since numerous modifications and variations therein will be apparent to those skilled in the art.

### EXAMPLES

Sheet molds used in casting were constructed from ¼ inch thick glass plates serving as mold side faces 14, which were separated using a thermoplastic elastomeric material as a spacer, serving as side walls 16 and mold floor 12. The spacer was sized to allow for sheets of varying area and thickness dimensions. Furthermore, the spacer was constructed to allow for injection of the reaction mixture at different locations of the mold through inlet 18. The assembled molds were preheated to 80° C. prior to casting.

Trivex® Lens Material Component TVX-20, available from PPG Industries, was used as the first component (Component A). This is an isocyanate terminated prepolymer with an isocyanate content of approximately 11.5%.

The second component (Component B) was prepared by blending trimethylolpropane and 1,4-butanediol at a proportion of 3:7 (w/w) under nitrogen atmosphere at 60° C. until homogeneous. Also added were 80 ppm of dibutyltin diacetate and 4 ppm of Quinizarin Blue.

Casting was accomplished using a Urethane Processor Model 601-000-346 from Max Machinery. Components A and B were added to the Urethane processor and heated to 80° C. The components, targeted to a molar ratio of 1:1, were then mixed with high shear for a short period of time. The resulting blended reaction mixture was injected into the sheet mold 10 at a selected location 18. The metering of the blended mixture was such that the rate of injection into the mold was at least 3000 g/min. The molds were supported on an adjustable platform, so that one of the glass surfaces rested flat on the platform. The platform was maintained at a specific angle a to the horizontal. Generally, when the mold was approximately filled halfway, the platform was gradually raised until close to orthogonal in position. Upon completion of the filling, the mold was then allowed to stay in such a position until gelation occurred. The mold was placed in an oven for 16 hours at a temperature of 125° C. Upon cooling, the polymer sheet was removed from the mold.

| | NCO:OH | | First | Second | | |
|---|---|---|---|---|---|---|
| | equiv | Mold | component | component | | Mold |
| Example | ratio | dimensions | flow rate | flow rate | Inlet location | angle |
| 1 | 1.0 | 26″ × 36″ × 1″ | 7500 g/min | 922 g/min | Lower corner, | 75° |
| | | | | | side wall | |
| 2 | 1.0 | 26″ × 36″ × 1″ | 7500 g/min | 922 g/min | Lower corner, | 45° |
| | | | | | side wall | |
| 3 | 1.0 | 26″ × 36″ × 1″ | 4800 g/min | 590 g/min | Floor of mold | 10° |
| 4 | 1.0 | 26″ × 36″ × 1″ | 4800 g/min | 590 g/min | Into open top | 10° |
| (Comparative) | | | | | of mold | |
| 5 | 0.87 | 16″ × 16″ × 3″ | 4000 g/min | 569 g/min | Lower corner, | 10° |
| | | | | | side wall | |
| 6 | 0.87 | 16″ × 16″ × 3″ | 4000 g/min | 569 g/min | Into open top | 10° |
| (Comparative) | | | | | of mold | |

The processes of Examples 1 and 2 yielded polymeric sheets with no visible striations. Examples 3 and 4 differed only in the inlet locations, as did Examples 5 and 6. The sheet prepared in Example 3, where the mold was filled from the floor, demonstrated no striations while that prepared in comparative Example 4, where the mold was filled from the open top, had major flow lines along the bottom. The sheet prepared in Example 5, where the mold was filled from the lower side wall, showed only minor striation while that of comparative Example 6, where the mold was filled from the open top, demonstrated striation.

Whereas particular embodiments of this invention have been described above for purposes of illustration, it will be evident to those skilled in the art that numerous variations of the details of the present invention may be made without departing from the invention as defined in the appended claims.

What is claimed is:

1. A method of preparing a cured, non-elastomeric polymeric sheet derived from a polyisocyanate, having an area of at least 900 cm² and a volume of at least 1600 cm³, the method comprising the steps of:
(a) providing a first component comprising a material having isocyanate functional groups and optionally a catalyst;
(b) providing a second, separate component comprising a material having active hydrogen functional groups that are reactive with isocyanate and optionally a catalyst, wherein the catalyst is present in at least one of the first and second components, and wherein when the active hydrogen functional groups in the second component include hydroxyl groups, the first and second components are initially heated to a temperature of at least 50° C.;
(c) combining the first and second components to form a reaction mixture;
(d) introducing the reaction mixture into a sheet maid at a fill rate of at least 3000 g/min in a substantially uniform thickness, wherein the sheet mold has been pre-heated to a temperature of at least 50° C.;
(e) holding the reaction mixture without additional heating to a higher temperature for a time sufficient to allow the reaction mixture to gel;
(f) heating the reaction mixture to a temperature and for a time sufficient to yield a cured sheet having a thickness of at least 635 mm (025 in); and
(g) removing the cured sheet from the mold to yield a non-elastomeric polymeric sheet.

2. The method of claim 1 wherein the first component comprises a urethane prepolymer having isocyanate functional groups.

3. The method of claim 1 wherein the second component comprises at least one polyol.

4. The method of claim 2, wherein the second component comprises a mixture of trimethylol propane and 1,4-butanediol.

5. The method of claim 1, wherein the catalyst is present it the second component.

6. The method of claim 5 wherein the catalyst comprises dibutyltin diacetate.

7. The method of claim 1 wherein the components are heated to a temperature up to 110° C. prior to being combined.

8. The method of claim 7 wherein the sheet mold is preheated to a temperature up to 110° C. prior to introduction of the reaction mixture into the mold.

9. The method of claim 1 wherein the reaction mixture is introduced into the sheet mold at a fill rate of at least 7000 g/min.

10. The method of claim 1 wherein the reaction mixture is introduced into the mold under laminar flow.

11. The method of claim 1 wherein the reaction mixture i held during step (e) for at least ten minutes.

12. The method of claim 1 wherein the reaction mixture is heated d rind step (f) to a temperature of 125° C. for 16 hours to yield a toured sheet.

13. The method of claim 1 wherein the mold is oriented such that a side face of the mold is at an angle to the horizontal of at least 10°.

14. The method of claim 13 wherein the mold is oriented such that a side face of the mold is at an angle to the horizontal of at least 45°.

15. The method of claim 1 wherein the thickness of the cured sheet formed in step (1) is 127 to 76.2 mm (0.5 to 3.0 in).

16. The method of claim 1 wherein the reaction mixture is introduced into the sheet mid through an inlet situated in the bottom surface of the mold.

17. The method of claim 17 wherein the reaction mixture is introduced into the sheet mold through an inlet situated in a side wall of the mold.

18. The method of claim 1 wherein the cured sheet is essentially free of striation defects.
